(19) United States
(12) Patent Application Publication
(10) Pub. No.: US 2014/0241121 A1
(43) Pub. Date: Aug. 28, 2014

(54) SYSTEMS AND METHODS FOR IMPROVING THE EFFICIENCY OF HYDROGENERATORS

(71) Applicant: CGG SERVICES SA, Massy Cedex (FR)

(72) Inventor: Patrick JONKE, Houston, TX (US)

(73) Assignee: CGG SERVICES SA, Massy Cedex (FR)

(21) Appl. No.: 14/186,382

(22) Filed: Feb. 21, 2014

Related U.S. Application Data
(60) Provisional application No. 61/767,876, filed on Feb. 22, 2013.

(51) Int. Cl. G01V 1/38; F03B 13/10; F01D 15/10; F03B 3/16

(52) U.S. Cl. CPC G01V 1/3826; F03B 3/16; F03B 13/10; F01D 15/10
USPC 367/17; 415/1; 290/52

(57) ABSTRACT

Systems and methods are provided for generating power by a hydrogenerator which can be attached to a portion of a towed marine streamer. A hydrogenerator includes: a stator configured to impart a spin to water which flows through the stator, wherein the stator is inline with and fluidly coupled to a propeller; the propeller configured to receive water which has passed through the stator, wherein the propeller is connected to a generator; the propeller configured to spin; and the generator configured to output power for use by components attached to the towed marine streamer.

### RELATED APPLICATIONS

The present application claims priority under 35 U.S.C. §119(e) to U.S. Provisional Patent Application Ser. No. 61/767,876, filed Feb. 22, 2013, for “Method for Improving the Efficiency of Hydrogenerators” the entire contents of which are expressly incorporated herein by reference.

### TECHNICAL FIELD

The embodiments relate generally to methods and systems and, more particularly, to methods and systems for improving the efficiency of hydrogenerators.

### BACKGROUND

A widely used technique for searching for hydrocarbons, e.g., oil and/or gas, is the seismic exploration of subsurface geophysical structures. Reflection seismology is a method of geophysical exploration to determine the properties of a portion of a subsurface layer in the earth, which information is especially helpful in the oil and gas industry. Marine-based seismic data acquisition and processing techniques are used to generate a profile (image) of a geophysical structure (subsurface) of the strata underlying the seafloor. This profile does not necessarily provide an accurate location for oil and gas reservoirs, but it may suggest, to those trained in the field, the presence or absence of oil and/or gas reservoirs. Thus, providing an improved image of the subsurface in a shorter period of time is an ongoing process.

The seismic exploration process includes generating seismic waves (i.e., sound waves) directed toward the subsurface area, gathering data on reflections of the generated seismic waves at interfaces between layers of the subsurface, and analyzing the data to generate a profile (image) of the geophysical structure, i.e., the layers of the investigated subsurface. This type of seismic exploration can be used both on the subsurface of land areas and for exploring the subsurface of the ocean floor.

Marine reflection seismology is based on the use of a controlled source that sends energy waves into the earth, by first generating the energy waves in or on the ocean. By measuring the time it takes for the reflections to come back to one or more receivers (usually very many, perhaps in the order of several dozen, or even hundreds), it is possible to estimate the depth and/or composition of the features causing such reflections. These features may be associated with subterranean hydrocarbon deposits.

Seismic waves are initiated by a source, follow one or more paths based on reflection and refraction until a portion of the seismic waves are detected by one or more receivers. Upon detection, data associated with the seismic waves is recorded and then processed for producing an accurate image of the subsurface. The processing can include various phases, e.g., velocity model determination, prestack, migration, poststack, etc., which are known in the art and thus, their description is omitted here.

For a seismic gathering process, as shown in FIG. 1, a data acquisition system 10 includes a ship 2 towing plural streamers 6 that may extend over kilometers behind ship 2. Each of the streamers 6 can include one or more birds 8 that maintains streamer 6 in a known fixed position relative to other streamers 6, and the birds 8 are capable of moving streamer 6 as desired according to bi-directional communications the birds 8 can receive from ship 2. One or more source arrays 4a,b may also be towed by ship 2 or another ship for generating seismic waves. Source arrays 4a,b can be placed either in front of or behind receivers (not shown), or both behind and in front of receivers. The seismic waves generated by source arrays 4a,b propagate downward, reflect off of, and penetrate the seafloor, wherein the refracted waves eventually are reflected by one or more reflecting structures (not shown) back to the surface. The reflected seismic waves propagate upwardly and are detected by receivers provided on streamers 6. This process is generally referred to as “shooting” a particular seafloor area, and the seafloor area can be referred to as a “cell”.

Various devices attached to marine streamers can use power. Extending the working power life of these devices is desirable as the downtime to replace a device with no or low power can be lengthy which in turn means additional cost. One method currently used to power some devices in this marine environment is to use a hydrogenerator, with a hydrogenerator being a device that converts mechanical energy of a moving fluid to electrical energy. A conventional hydrogenerator 12, as shown in FIG. 2, includes a propeller 14 attached to a generator 16, which may be an alternating current (AC) or a direct current (DC) generator. As the ship 2 moves through the water with a deployed streamer 6 with an attached hydrogenerator, the motion allows water to flow over the propellers which in turn rotates the propellers which turns a shaft allowing power to be generated by the generator 16 (for simplicity and as it is known in the art, the full description of how the power is generated is omitted).

Another conventional hydrogenerator 18 is shown in FIG. 3. This hydrogenerator 18 includes a propeller 22, a generator 24 and a debris shield 20. The debris shield 20 may be optional and is configured to protect the propeller by deflecting debris and preventing marine organisms from contacting the rest of the hydrogenerator 18.

However, not in all cases do conventional hydrogenerators meet all of the power needs of devices on a towed marine streamer.

Accordingly, it would be desirable to provide methods and systems that avoid the afore-described problems and drawbacks.

### SUMMARY

According to an embodiment there is a seismic acquisition system comprising: a stator configured to impart a spin to water which flows through the stator, wherein the stator is inline with and fluidly coupled to a propeller, wherein the stator is made from a sufficiently strong material; the propeller configured to receive water which has passed through the stator, wherein the propeller is connected to a generator, further wherein the propeller includes a plurality of blades whose shape is described by a complex curve; the propeller configured to spin; the generator configured to output power for use by components attached to the towed marine streamer, wherein the generator and the stator are physically connected by a frame; at least one seismic source attached to the towed marine streamer configured to emit a seismic signal; at least one bird attached to the towed marine streamer configured to maintain the towed marine streamer in a known fixed position relative to other towed marine streamers; and at least one receiver attached to the towed marine streamer configured to receive the seismic signal.

According to an embodiment there is a hydrogenerator configured to generate power which is attached to a portion of a towed marine streamer including: a stator configured to impart a spin to water which flows through the stator, wherein the stator is inline with and fluidly coupled to a propeller; the propeller configured to receive water which has passed through the stator, wherein the propeller is connected to a generator; the propeller configured to spin; and the generator configured to output power for use by components attached to the towed marine streamer.

According to an embodiment there is a method for generating power by a hydrogenerator which is attached to a portion of a towed marine streamer, the method including: imparting, by a stator, a spin to water which flows through the stator, wherein the stator is inline with and fluidly coupled to a propeller; receiving, by a propeller, the water which has been passed through the stator, wherein the propeller is connected to a generator; spinning the propeller; and generating power, by the generator, for use by components attached to the towed marine streamer.

### BRIEF DESCRIPTION OF THE DRAWINGS

The accompanying drawings illustrate exemplary embodiments, wherein:

FIG. 1 shows a conventional data acquisition system in a marine environment;

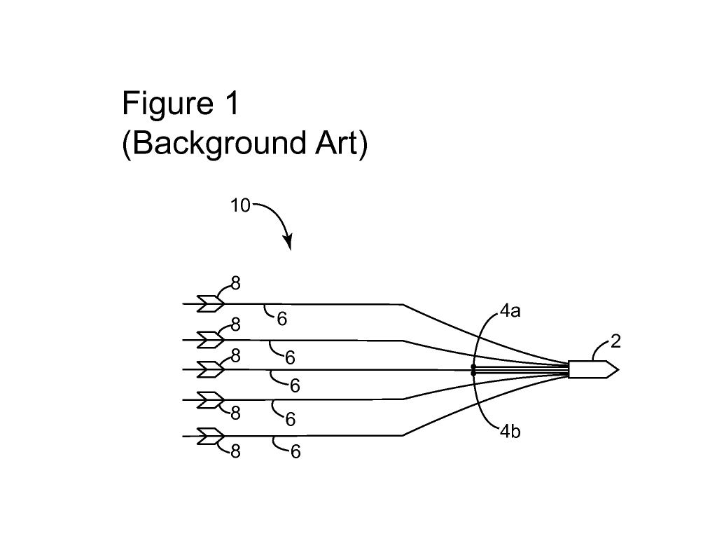

FIG. 2 depicts a hydrogenerator;

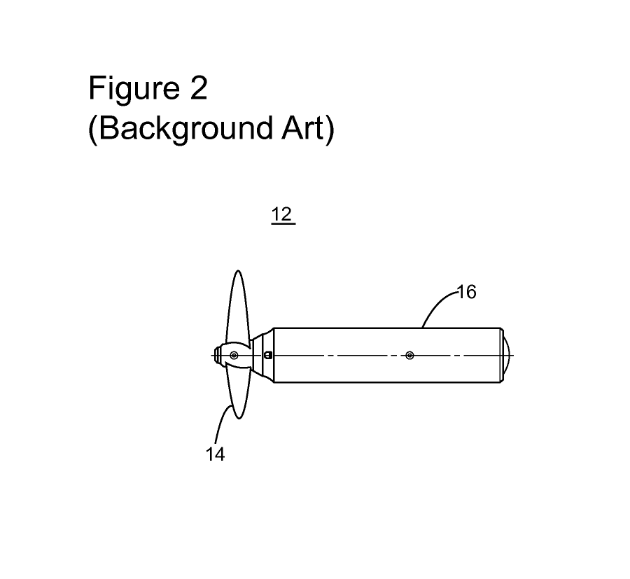

FIG. 3 illustrates a hydrogenerator with a debris guard;

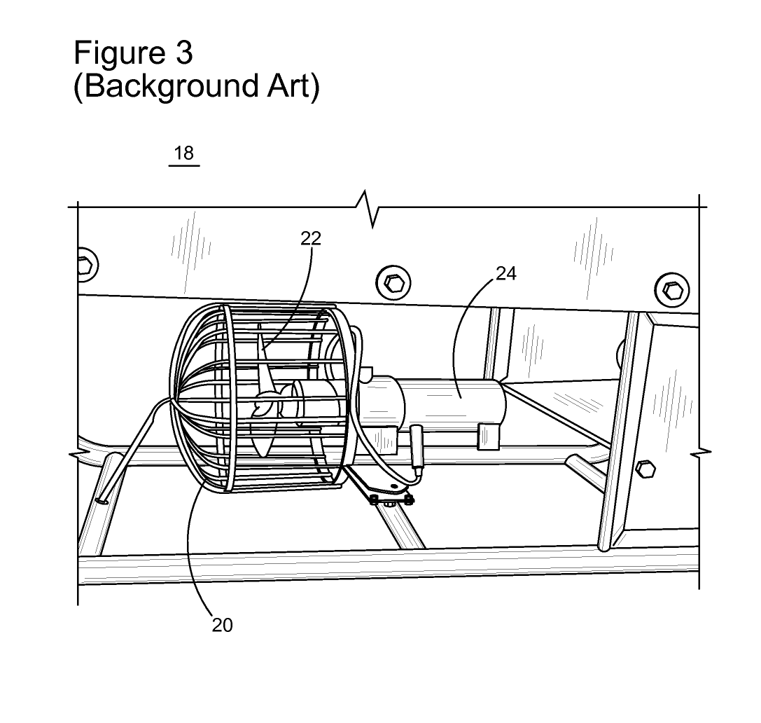

FIG. 4 shows a data acquisition system in a marine environment according to an embodiment;

FIG. 5 depicts a side view of the data acquisition system in a marine environment according to an embodiment;

FIG. 6 shows a marine streamer with a curved profile according to an embodiment;

FIG. 7 illustrates a multi-level source according to an embodiment;

FIG. 8 shows a stator according to an embodiment;

FIG. 9 shows a stator connected to a debris guard according to an embodiment;

FIG. 10 depicts a hydrogenerator according to an embodiment;

FIG. 11 depicts a hydrogenerator and a stator connected via a frame according to an embodiment; and

FIG. 12 shows a flowchart of a method according to an embodiment.

### DETAILED DESCRIPTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular feature, structures, or characteristics may be combined in any suitable manner in one or more embodiments.

According to embodiments, and in order to address, among other things, the problems discussed in the Background, it is desirable to improve the power output of hydrogenerators for power components of a marine seismic streamer. Embodiments can improve the power output of hydrogenerators by imparting a spin on water prior to the water impacting a propeller attached to a generator. Prior to discussing embodiments in detail, an environment in which hydrogenerators can be used is described.

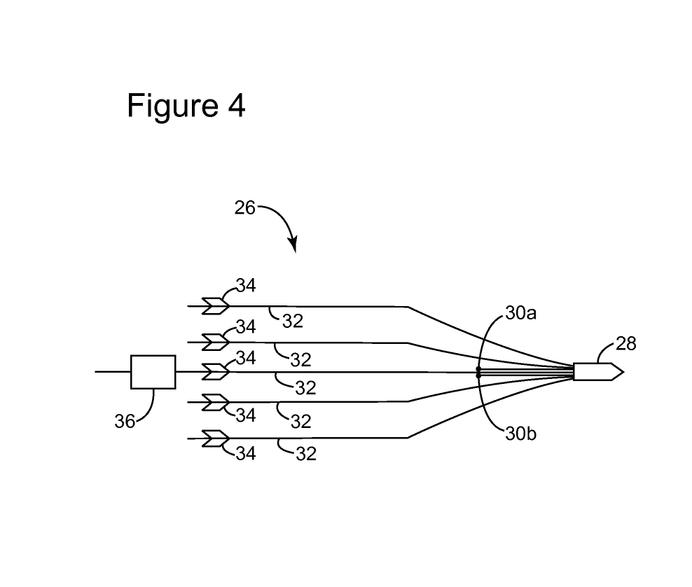

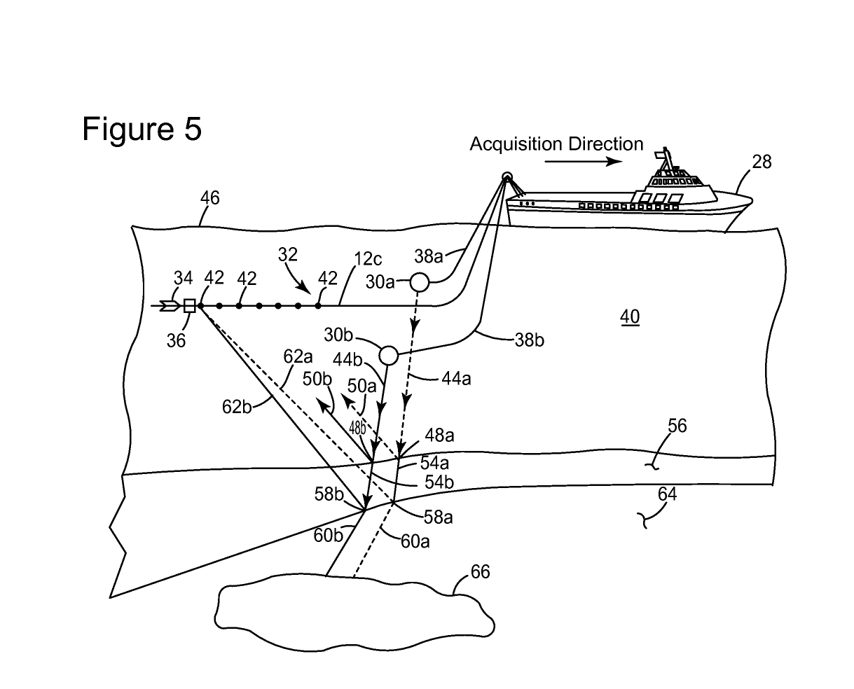

For a seismic gathering process, as shown in FIG. 4, a data acquisition system 26 includes a ship 28 towing plural streamers 32 that may extend over kilometers behind ship 28. Each of the streamers 32 can include one or more birds 34 that maintains streamer 32 in a known fixed position relative to other streamers 32, and the birds 34 are capable of moving streamer 32 as desired according to bi-directional communications the birds 34 can receive from ship 28. One or more source arrays 30a,b may also be towed by ship 28 or another ship for generating seismic waves. Source arrays 30a,b can be placed either in front of or behind receivers 42 (shown in FIG. 5), or both behind and in front of receivers 42. The seismic waves generated by source arrays 30a,b propagate downward, reflect off of, and penetrate the seafloor, wherein the refracted waves eventually are reflected by one or more reflecting structures (not shown in FIG. 4) back to the surface (see FIG. 5, discussed below). The reflected seismic waves propagate upwardly and are detected by receivers 42 provided on streamers 32. According to an embodiment a hydrogenerator 36 can be attached to one or more streamers 32 or attached to a device on one or more streamers 32 to generate power when the streamers 32 are being towed through the water by ship 28.

FIG. 5 illustrates a side view of the data acquisition system 26 of FIG. 4. Ship 28, located on ocean surface 46 of ocean water 40, tows one or more streamers 32, that is comprised of cables 38, and a plurality of receivers 42. Shown in FIG. 5 are two source streamers which include sources 30a,b attached to respective cables 38a,b. Each source 30a,b is capable of transmitting a respective sound wave, or transmitted signal 44a,b. For the sake of simplifying the drawings, but while not detracting at all from an understanding of the principles involved, only a first transmitted signal 44a will be discussed in detail (even though some or all of sources 30a,b can be simultaneously (or not) transmitting similar transmitted signals 44). First transmitted signal 44a travels through ocean 40 and arrives at a first refraction/reflection point 48a. First reflected signal 50a from first transmitted signal 44a travels upward from ocean floor 52, back to receivers 42. As those of skill in the art can appreciated, whenever a signal—optical or acoustical—travels from one medium with a first index of refraction n₁ and meets with a different medium, with a second index of refraction n₂, a portion of the transmitted signal is reflected at an angle equal to the incident angle (according to the well-known Snell's law), and a second portion of the transmitted signal can be refracted (again according to Snell's law).

Thus as shown in FIG. 5, first transmitted signal 44a generates first reflected signal 50a, and first refracted signal 54a. First refracted signal 26a travels through sediment layer 56 (which can be generically referred to as first subsurface layer 56) beneath ocean floor 52, and can now be considered to be a “new” transmitted signal, such that when it encounters a second medium at second refraction/reflection point 58a, a second set of refracted and reflected signals 60a and 62a, are subsequently generated. Further, as shown in FIG. 5, there happens to be a significant hydrocarbon deposit within a third medium, or solid earth/rock layer 64 (which can be generically referred to as second subsurface layer 64). Consequently, refracted and reflected signals are generated by the hydrocarbon deposit, and it is a purpose of the data acquisition system 26 to generate data that can be used to discover such hydrocarbon deposits 66.

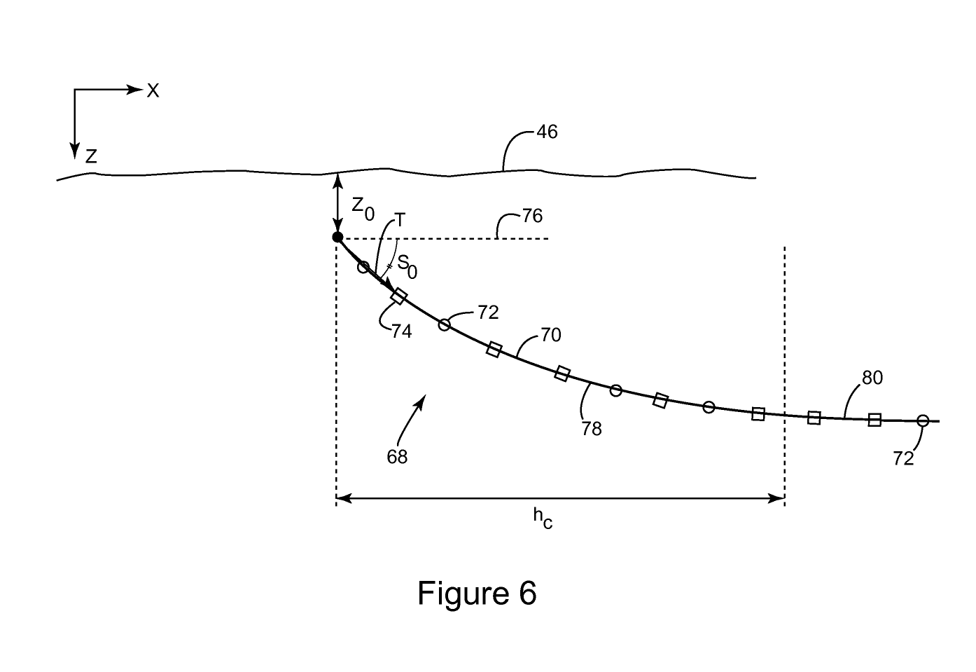

According to an embodiment, streamers may be horizontal or slanted or having a curved profile as illustrated in FIG. 6. The curved streamer 68 of FIG. 6 includes a body 70 having a predetermined length; plural detectors 72 provided along the body 70; and plural birds 74 provided along the body for maintaining the selected curved profile. The streamer 68 is configured to flow underwater when towed such that the plural detectors 72 are distributed along the curved profile. The curved profile may be described by a parameterized curve, e.g., a curve described by (i) a depth z₀ of a first detector (measured from the water surface 46), (ii) a slope s₀ of a first portion T of the body with an axis 76 parallel with the water surface 46, and (iii) a predetermined horizontal distance h_{c} between the first detector and an end of the curved profile. It is noted that not the entire streamer has to have the curved profile. In other words, the curved profile should not be construed to always apply to the entire length of the streamer. While this situation is possible, the curved profile may be applied only to a portion 78 of the streamer 68. In other words, the streamer 68 may have (i) only a portion 78 having the curved profile or (ii) a portion 78 having the curved profile and a portion 80 having a flat profile, the two portions being attached to each other.

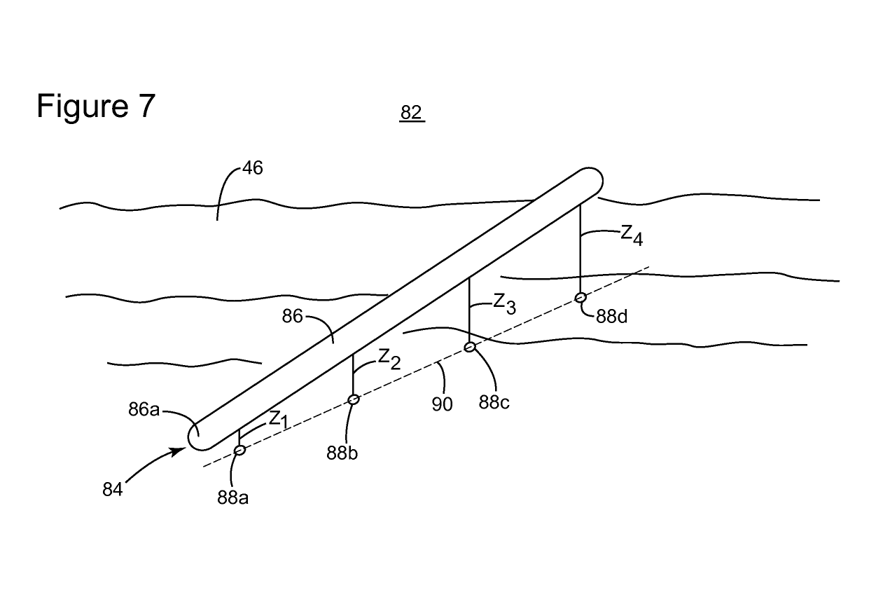

According to another embodiment, a multi-level source 82 which can have one or more sub-arrays can be used as is shown in FIG. 7. The first sub-array 84 has a float 86 that is configured to float at the water surface 46 or underwater at a predetermined depth. Plural source points 88a-d are suspended from the float 86 in a known manner. A first source point 88a may be suspended closest to the head 86a of the float 86, at a first depth z1. A second source point 88b may be suspended next, at a second depth z2, different from z1. A third source point 88c may be suspended next at a third depth z3, different from z1 and z3, and so on. FIG. 7 shows, for simplicity, only four source points 88a-d, but an actual implementation may have any desired number of source points. In one application, because the source points are distributed at different depths, the source points at the different depths are not simultaneously activated. In other words, the source array is synchronized, i.e., a deeper source point is activated later in time (e.g., 2 ms for 3m depth difference when the speed of sound in water is 1500 m/s) such that corresponding sound signals produced by the plural source points coalesce, and thus, the overall sound signal produced by the source array appears as being a single sound signal.

The depths z1 to z4 of the source points of the first sub-array 84 may obey various relationships. In one application, the depths of the source points increase from the head toward the tail of the float, i.e., z1<z2<z3<z4. In another application, the depths of the source points decrease from the head to the tail of the float. In another application, the source points are slanted, i.e., provided on an imaginary line 90. In still another application, the line 90 is a straight line. In yet another application, the line 90 is a curved line, e.g., part of a parabola, circle, hyperbola, etc. In one application, the depth of the first source point for the sub-array 84 is about 5 m and the largest depth of the last source point is about 8 m. In a variation of this embodiment, the depth range is between 8.5 m and 10.5 m or between 11 m and 14 m. In another variation of this embodiment, when the line 90 is straight, the depths of the source points increase by 0.5 m from a source point to an adjacent source point. Those skilled in the art would recognize that these ranges are exemplary and these numbers may vary from survey to survey. A common feature of all these embodiments is that the source points have variable depths so that a single sub-array exhibits multiple-level source points.

As can be seen from the preceding paragraphs, there are a number of components associated with marine streamers many of which use power during operation. Having described various environments in which towed marine streamers and their components can operate, embodiments describing hydrogenerators are now described.

According to an embodiment, there is a method for improving the efficiency of a hydrogenerator. In this method, a fixed set of stator blades a can be placed in front of the hydrogenerator's propeller to increase the efficiency of the hydrogenerator, e.g., increase the output power. The angle and pitch of the blades of the stator can be tuned to water velocities typically encountered when the system is in use. By imparting a pre-spin to the water flow, an improvement to the fluid coupling of the stator to a propeller can be achieved. According to an embodiment, by adjusting the size of each blade of the stator and ensuring that the blades have a rounded leading edge and are densely spaced the placement of the stator does not reduce the debris guarding function which the stator can perform instead of a traditional debris guard. Alternatively, the stator can be attached to a traditional debris guard. Additionally, the debris guard (or shield) provides an additional element of safety as the debris guard can also protect individuals in the water from contacting the propeller 22 as people can on occasion fall overboard.

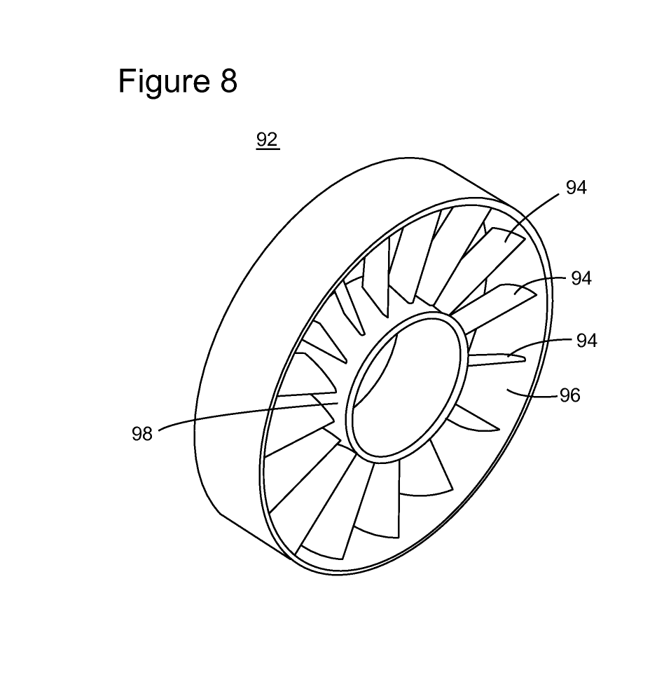

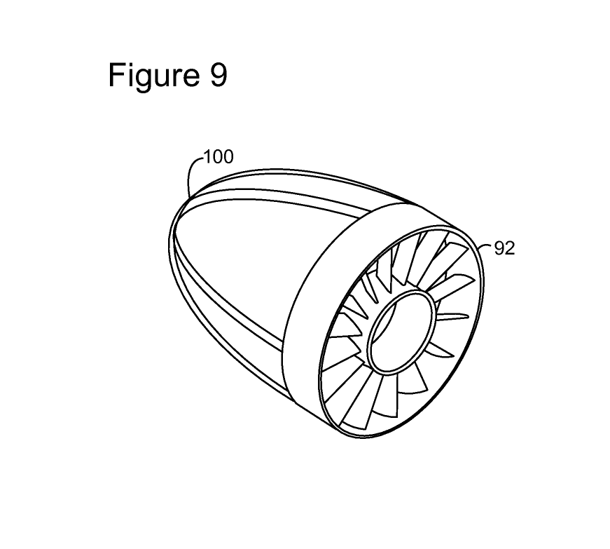

According to an embodiment, as described above, the stator can have a fixed set of blades as shown in FIG. 8. The stator 92 includes a plurality of fixed blades 94 for which the angle and pitch can be tuned to water velocities typically encountered when the system is in use. The shape of the blades can be in the form of a complex curve. The fixed blades can be mounted to the inside of an outer ring 96 and the outside of an inner ring 98. According to an embodiment, FIG. 9 shows the stator 92 attached to a debris guard 100. According to an embodiment, the stator can be created from any material, e.g., a molded fiber-reinforced resin, which would be sufficiently strong and have other properties as desired, such as, adequate corrosion resistance.

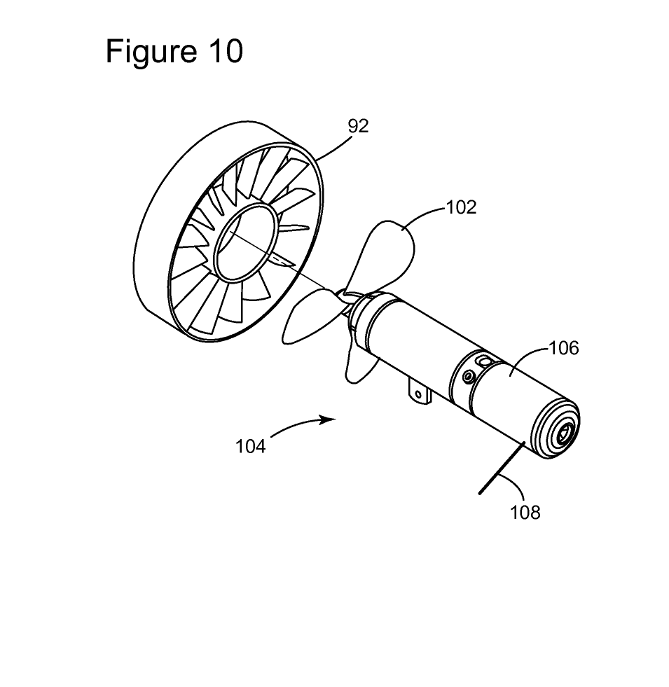

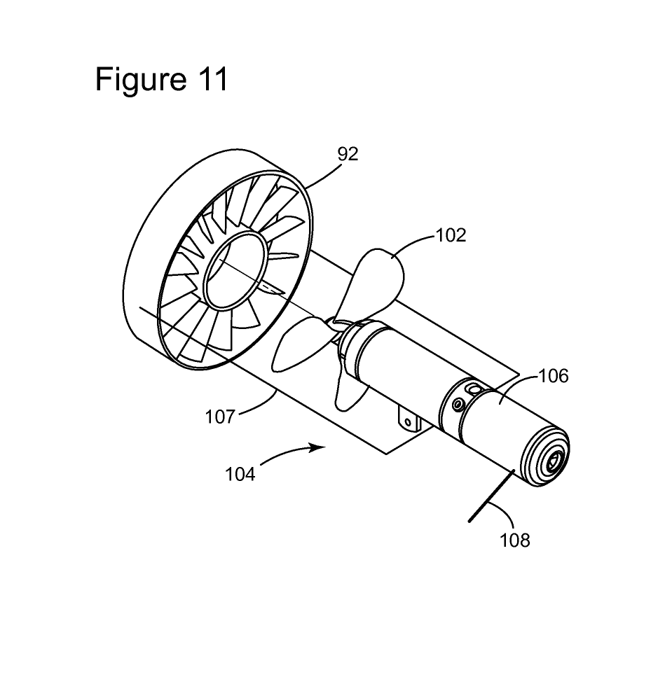

According to an embodiment, the stator 92 can be fluidly coupled to the propeller 102 of the hydrogenerator 104 as shown in FIG. 10. Hydrogenerator 104 includes a propeller 102, a power generation section 106, e.g., an AC generator or a DC generator, and a conduit or cable 108 which can be used for power transmission and/or communications with other components on the towed marine streamer. The stator 92 can be inline with the propeller 102. The stator 92 can also impart a so-called “pre-spin” on the water, the water with the spin then interacts with the propeller 102 to improve its efficiency and hence increases the power output of the hydrogenerator 104. This pre-spin can further be described as the water is moving in a spiral motion before that water contacts the propeller blades of the hydrogenerator 104 so that energy is not wasted in changing the direction of the water before it applies torque to the propeller shaft. Additionally, the debris guard 100 (shown in FIG. 9) can be included. According to another embodiment, the hydrogenerator 104 can include a debris guard 100, the stator 92 (which may or may not be a part of the debris guard 100), a propeller 102 and a power generation section 106 as a physically connected unit. According to an embodiment, the stator 92 and the hydrogenerator 104 can be physically connected to each other by, for example, being attached to a same frame 107 as shown in FIG. 11. This attachment to a same frame 107 can allow for additional torque from the stator 92 to not negatively affect the hydrogenerator 104.

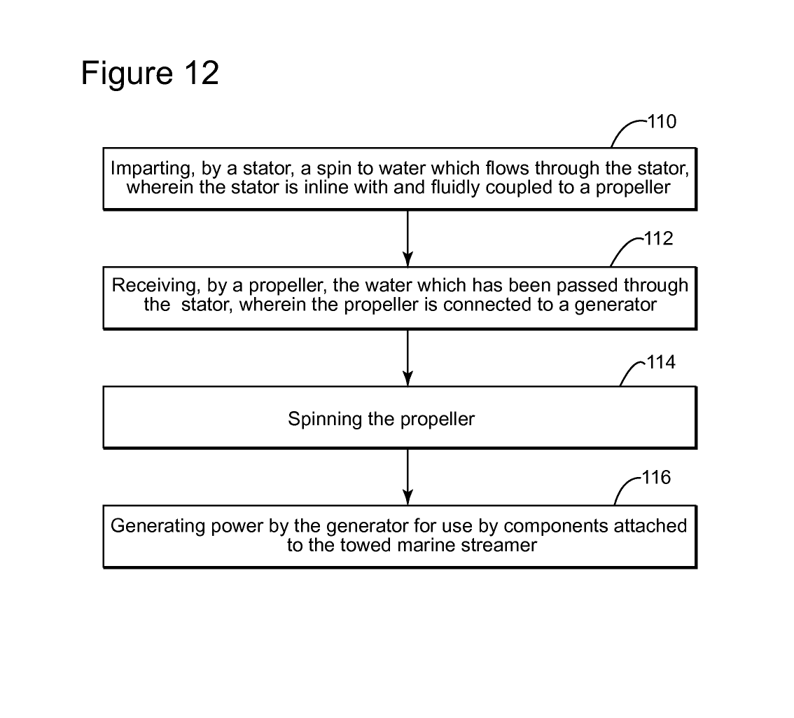

Utilizing the above-described exemplary systems according to exemplary embodiments, a method for generating power by a hydrogenerator which is attached to a portion of a towed marine streamer is shown in the flowchart of FIG. 12. The method includes: at step 110, imparting, by a stator, a spin to water which flows through the stator, wherein the stator is inline with and fluidly coupled to a propeller; at step 112, receiving, by a propeller, the water which has been passed through the stator, wherein the propeller is connected to a generator; at step 114, spinning the propeller; and at step 116, generating power by the generator for use by components attached to the towed marine streamer.

The method described with respect to FIG. 12 can further include other steps and description. For example, there can be a debris guard configured to prevent debris, marine life and people that are in the water from contacting the propeller which is located in front of the propeller and connected to the stator. According to an embodiment, the generator can generate an alternating current. Alternatively, the generator can generate a direct current. The method can also include transmitting power through a cable from the hydrogenerator to at least one component attached to the towed marine streamer. Additionally, the method can include the steps of: emitting, by at least one seismic source attached to the towed marine streamer, a seismic signal; maintaining, by at least one bird attached to the towed marine streamer, the towed marine streamer in a known fixed position relative to other towed marine streamers; and receiving, by at least one receiver attached to the towed marine streamer, the seismic signal.

The disclosed embodiments provide an apparatus and a method for improving the efficiency of hydrogenerators. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims. No element, act, or instruction used in the description of the present application should be construed as critical or essential to the invention unless explicitly described as such. Also, as used herein, the article “a” is intended to include one or more items.

What is claimed is:

1. A seismic acquisition system comprising:
a stator configured to impart a spin to water which flows through the stator, wherein the stator is inline with and fluidly coupled to a propeller, wherein the stator is made from a sufficiently strong material;
the propeller configured to receive water which has passed through the stator, wherein the propeller is connected to a generator, further wherein the propeller includes a plurality of blades whose shape is described by a complex curve;
the propeller configured to spin;
the generator configured to output power for use by components attached to the towed marine streamer, wherein the generator and the stator are physically connected by a frame;
at least one seismic source attached to the towed marine streamer configured to emit a seismic signal;
at least one bird attached to the towed marine streamer configured to maintain the towed marine streamer in a known fixed position relative to other towed marine streamers; and
at least one receiver attached to the towed marine streamer configured to receive the seismic signal.

2. A hydrogenerator configured to generate power which is attached to a portion of a towed marine streamer comprising:
a stator configured to impart a spin to water which flows through the stator, wherein the stator is inline with and fluidly coupled to a propeller;
the propeller configured to receive water which has passed through the stator, wherein the propeller is connected to a generator;
the propeller configured to spin; and
the generator configured to output power for use by components attached to the towed marine streamer.

3. The hydrogenerator of claim 2, further comprising:
a debris guard configured to prevent debris from contacting the propeller which is located in front of the propeller and connected to the stator.

4. The hydrogenerator of claim 2, wherein the generator generates an alternating current.

5. The hydrogenerator of claim 2, wherein the generator generates a direct current.

6. The hydrogenerator of claim 2, further comprising:
a cable configured to transmit power from the hydrogenerator to a component attached to the towed marine streamer.

7. The hydrogenerator of claim 2, further comprising:
a cable configured to transmit power from the hydrogenerator to a plurality of components attached to the towed marine streamer.

8. The hydrogenerator of claim 2, further comprising:
at least one seismic source attached to the towed marine streamer configured to emit a seismic signal;
at least one bird attached to the towed marine streamer configured to maintain the towed marine streamer in a known fixed position relative to other towed marine streamers; and
at least one receiver attached to the towed marine streamer configured to receive the seismic signal.

9. The hydrogenerator of claim 2, wherein the stator is made from a molded fiber reinforced resin.

10. The hydrogenerator of claim 2, wherein the hydrogenerator and the stator are physically connected to a same frame.

11. The hydrogenerator of claim 2, wherein the stator includes a plurality of blades, wherein the shape of the blades is described by a complex curve.

12. The hydrogenerator of claim 2, wherein imparting the spin to water which flows through the stator increases output power of the generator.

13. The hydrogenerator of claim 2, wherein the stator is configured to prevent debris from contacting the propeller.

14. A method for generating power by a hydrogenerator which is attached to a portion of a towed marine streamer, the method comprising:
imparting, by a stator, a spin to water which flows through the stator, wherein the stator is inline with and fluidly coupled to a propeller;
receiving, by a propeller, the water which has been passed through the stator, wherein the propeller is connected to a generator;
spinning the propeller; and
generating power, by the generator, for use by components attached to the towed marine streamer.

15. The method of claim 14, further comprising:
transmitting power by a cable from the hydrogenerator to at least one component attached to a towed marine streamer.

16. The method of claim 15, further comprising:
emitting a seismic signal from at least one seismic source attached to the towed marine;
maintaining the towed marine streamer in a known fixed position relative to other towed marine streamers by at least one bird attached to the towed marine streamer; and
receiving the seismic signal by at least one receiver attached to the towed marine streamer.

17. The method of claim 14, wherein the stator is made from a molded fiber reinforced resin.

18. The method of claim 14, wherein the hydrogenerator and the stator are physically connected to a same frame.

19. The method of claim 14, further comprising:
generating an alternating current by the generator.

20. The method of claim 14, further comprising:
generating a direct current by the generator.
